(19) United States
(12) Patent Application Publication
(10) Pub. No.: US 2023/0244951 A1
(43) Pub. Date: Aug. 3, 2023

(54) SUSTAINABLE CONTINUAL LEARNING WITH DETECTION AND KNOWLEDGE REPURPOSING OF SIMILAR TASKS

(71) Applicants: Samsung Electronics Co., Ltd., Gyeonggi-do (KR); Duke University, Durham, NC (US)

(72) Inventors: Yoo Jin CHOI, San Diego, CA (US); Mostafa EL-KHAMY, San Diego, CA (US); Sijia WANG, Durham, NC (US); Ricardo Henao GIRALDO, Durham, NC (US); Junya CHEN, Durham, NC (US)

(21) Appl. No.: 18/099,631

(22) Filed: Jan. 20, 2023

Related U.S. Application Data
(60) Provisional application No. 63/303,323, filed on Jan. 26, 2022.
(60) Provisional application No. 63/425,934, filed on Nov. 16, 2022.

(51) Int. Cl. G06N 3/096; G06N 3/042

(52) U.S. Cl. CPC G06N 3/096; G06N 3/042

(57) ABSTRACT

Disclosed is a method and apparatus for dynamic models to identify similar tasks when no task identifier is provided during the training phase in continual learning (CL). The method includes maintaining a memory comprising one or more previously learned tasks, determining, in response to receiving a new task, one of more similarities between at least one previously learned task and the new task, generating, based on the one or more similarities determined and a previously used task-specific encoder corresponding to the at least one previously learned task, a test error value for classifying the new task, and applying the previously used task-specific encoder to the new task based on the generated test error value.

### CROSS-REFERENCE TO RELATED APPLICATION(S)

This application claims the benefit under 35 U.S.C. § 119(e) of U.S. Provisional Application Ser. Nos. 63/303,323 and 63/425,934, which were filed in the U.S. Patent and Trademark Office on Jan. 26, 2022, and Nov. 16, 2022, respectively, the disclosures of which are incorporated by reference in their entireties as if fully set forth herein.

### TECHNICAL FIELD

The disclosure generally relates to continual learning (CL). More particularly, the subject matter disclosed herein relates to improvements to model generation and training in a CL environment.

### SUMMARY

CL techniques are related to learning from a stream of data, with the goal of memorizing previously learned knowledge and trying to succeed on the current task. Conventional CL techniques often involve a task continual learning (TCL) setting in which data arrives sequentially in groups of tasks.

FIGS. 1-4 describe prior art CL models subject to the contemporary problems described herein. FIG. 1 illustrates a CL method 100 according to prior art. In FIG. 1, task 1 and task 2 are received in sequential order as a sequence of new data in step 105. In step 110, knowledge is transferred from previously learned tasks. In step 115, new knowledge is stored for future use since the trainee may forget the old tasks. In step 120, existing knowledge is refined. That is, learned knowledge 121 is received in step 110 and is transferred to a learning model 122 which covers the sequence of tasks and outputs new knowledge, received in step 115. The new knowledge is stored and refined in step 120. A task t−1 is processed in the learning model 122 with the knowledge transferred in step 110, and at the conclusion of the method, it is determined in step 125 by a trainee that task 1, task 2, task t−1 and task t can be solved.

To mitigate catastrophic forgetting (CF), knowledge is refined in step 120 of FIG. 1 by adapting the learned models with new data and overwriting weights of the learned models to generalize the new data, In particular, regularization based, memory-replay based, and dynamic model-based CL methods could be considered strategies for mitigating the CF issue.

FIG. 2 illustrates a regularization-based CL method 200, according to the prior art. In FIG. 2, the method is based on the imposing constraints on the update of weights.

In this model, elastic weight consolidation (EWC) is employed to only change the unimportant weights for previous tasks.

Specifically, in the calculation 201, a task B loss or regularization constraint is added to constraints on parameters trained on task A, thereby enabling the model [symbol] (θ) to “remember” the previously learned tasks. As noted above, the goal is to maintain the important weights for previous tasks and to only change the unimportant weights in the EWC shown in diagram 202. In this case, the task B loss model is unchanged but the regularization terms from the learning phase are added to this model. Thus, while a low memory budget is achieved, the model size imposes constraints since the ability to remember previous knowledge declines when dealing with a long sequence of tasks, negatively affecting this model.

FIG. 3 illustrates a memory-replay based CL method 300, according to prior art. In FIG. 3, the method is based on experience/exact replay (ER) by which representative samples are stored in memory, as well as deep generative replay (DGR) by which a generative model and draw samples from a generative model are trained.

Specifically, in a sequential training function, representative (i.e., old) samples (task 1-task N) 301 are stored in memory and are re-used by a training generator 302 when learning a new task. Alternatively, instead of storing the old samples 301, a training solver 302 can train the old scholar to generate the old samples as a new scholar. Thus, while CF is mitigated in the memory-replay based CL method 300, since the old samples are maintained, the memory space is compromised.

FIG. 4 illustrates the dynamic model-based CL method 400, according to prior art. In FIG. 4, the method 400 is based on enabling the model to grow over time, in the manner of a progressive neural network.

Specifically, the new model continuously grows as new tasks are learned, which has the benefit of making it less likely to forget data when a long sequence is learned. However, this method incurs a prohibitive memory expansion in the process.

That is, while the above generative replay based and dynamic model-based methods tend to achieve promising performance, these are all parameter expansion approaches, and the size of the model/framework grows linearly with the number of tasks. This problem of infinite parameter expansion is critical but is currently unaddressed in the prior art.

Additionally, previous continual learning works, such as those described above, operate by assuming the sequence of tasks are completely different, when the opposite is often true in practice. For example, when a model has “seen” enough tasks, it is very likely that a new task or a new dataset has already been learned by the model. Retraining a model with these tasks is a waste of valuable memory space and computational resources, which are now spent to retrain a new set of task-specific parameters that may have already existed from a previous task.

Once a new task is presented, all of the data of the new task becomes readily available for batch (offline) training. In this setting, a task is defined as an individual training phase with a new collection of data that belongs to a new and unforeseen group of classes or a new domain. The TCL implicitly requires a task identifier during training. In practice, however, when the model has seen enough tasks, a newly arriving batch of data becomes increasingly likely to belong to the same group of classes or domain of a previously seen task. The conventional art on TCL fails to rectify this critical error.

Moreover, a task definition or identifier for a task may not be available during training. For example, the model may not have access to the task description due to user privacy concerns, lack of connectivity to a repository, lack of sufficient basis to generate a definition, etc. In such cases, the system considers every task as new, and therefore, constantly learns new sets of parameters regardless of task similarity or overlap. This constitutes a suboptimal use of computing resources, particularly as the number of tasks experienced by the CL system increases.

Accordingly, an aspect of the disclosure is to provide a paradigm where the continual learner receives a sequence of mixed similar and dissimilar tasks.

Another aspect of the disclosure is to provide a memory-efficient CL system which, though focused on image classification tasks, is general and in principle can be readily used toward other applications or data modality settings.

Another aspect of the disclosure is to provide a new framework for a practical TCL setting in which it is sought to learn a sequence of mixed similar and dissimilar tasks, while preventing (catastrophic) forgetting and repurposing task-specific parameters from a previously seen similar task, thereby decreasing memory expansion.

Another aspect of the disclosure is to provide a new continual learning framework that uses a task similarity detection function that does not require additional learning, with which an analysis is made on whether there is a specific past task that is similar to the current task. From there, previous task knowledge is reused to decelerate parameter expansion, ensuring that the CL system sublinearly expands a knowledge repository to the number of learned tasks.

In accordance with an aspect of the disclosure, a method of continual learning includes maintaining a memory comprising one or more previously learned tasks, determining, in response to receiving a new task, one of more similarities between at least one previously learned task and the new task, generating, based on the one or more similarities determined and a previously used task-specific encoder corresponding to the at least one previously learned task, a test error value for classifying the new task, and applying the previously used task-specific encoder to the new task based on the generated test error value.

In accordance with an aspect of the disclosure, a user equipment (UE) includes at least one processor, and at least one memory operatively connected with the at least one processor, the at least one memory storing instructions, which when executed, instruct the at least one processor to perform a method of continual learning by maintaining a memory comprising one or more previously learned tasks, determining, in response to receiving a new task, one of more similarities between at least one previously learned task and the new task, generating, based on the one or more similarities determined and a previously used task-specific encoder corresponding to the at least one previously learned task, a test error value for classifying the new task, and applying the previously used task-specific encoder to the new task based on the generated test error value.

### BRIEF DESCRIPTION OF THE DRAWINGS

In the following section, the aspects of the subject matter disclosed herein will be described with reference to exemplary embodiments illustrated in the figures, in which:

FIG. 1 illustrates a CL method 100 according to the prior art;

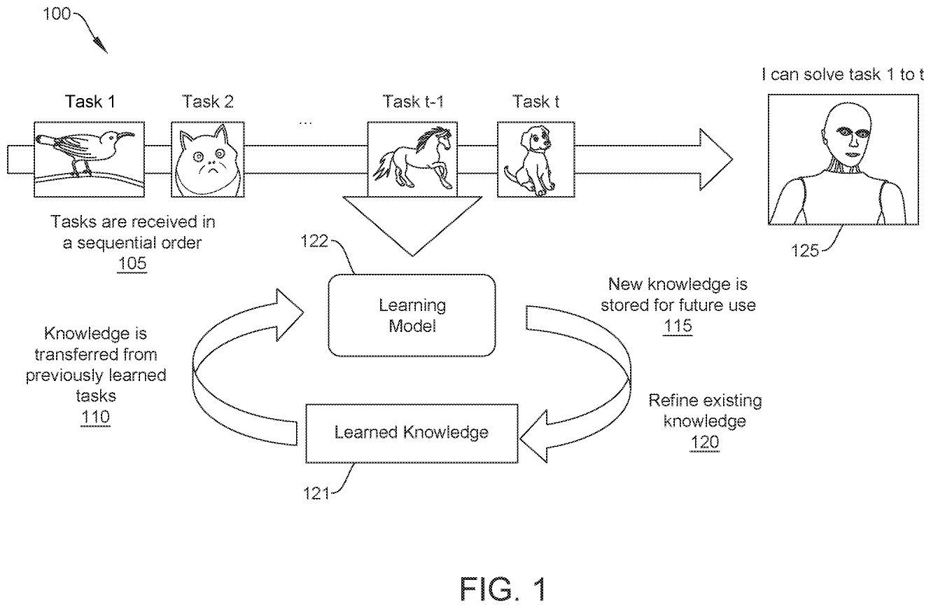

FIG. 2 illustrates the regularization-based CL method 200, according to the prior art;

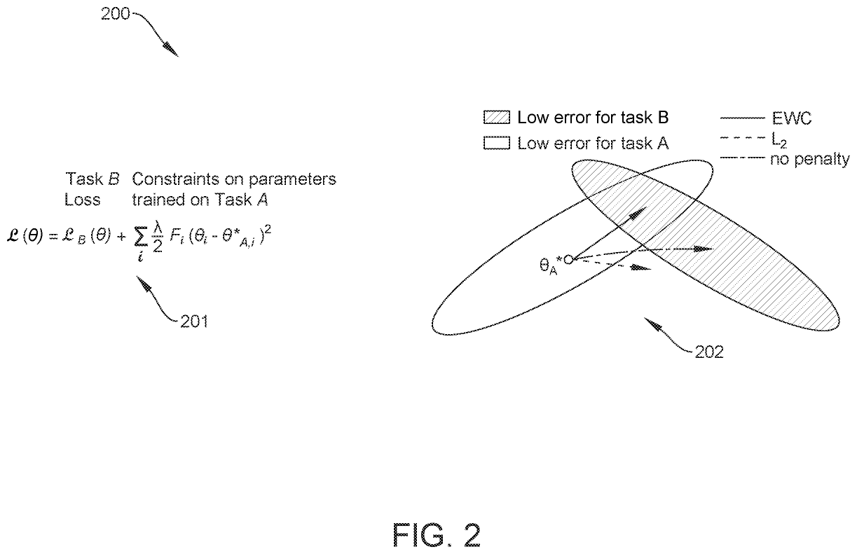

FIG. 3 illustrates the memory-replay based CL method 300, according to the prior art;

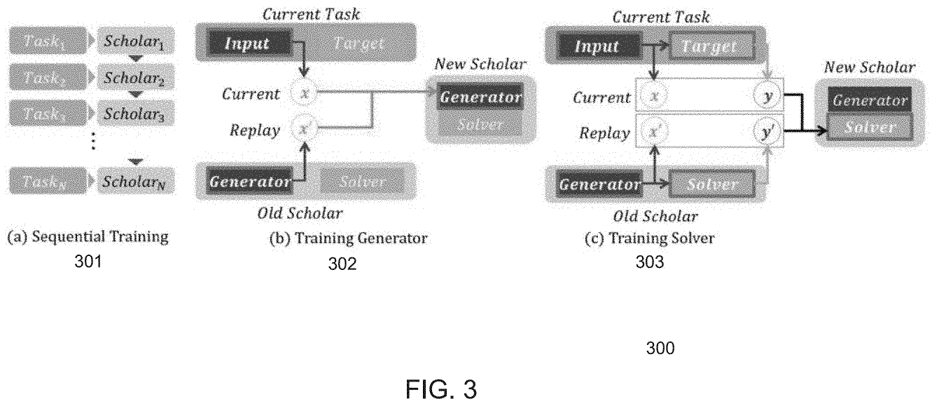

FIG. 4 illustrates the dynamic model-based CL method 400, according to the prior art;

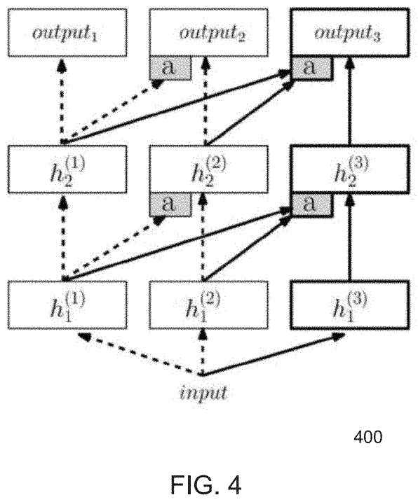

FIG. 5 illustrates a block diagram of a CL method 500, according to an embodiment; and

FIG. 6 illustrates a block diagram of an electronic device in a network environment 600, according to an embodiment.

### DETAILED DESCRIPTION

In the following detailed description, numerous specific details are set forth to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments.

Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singularly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

Herein, a solution is disclosed for dynamic models to identify similar tasks when no task identifier is provided during the training phase. Previous attempts to implement CL models involve a task similarity function to identify previously seen similar tasks, which requires training a reference model every time a new task becomes available. In this disclosure, a novel CL framework is described wherein similar tasks are identified without the need for training a new model, by leveraging a task similarity metric which results in high task similarity identification accuracy. The disclosed TCL framework is characterized by a task similarity detection module that determines, without additional learning, whether the CL system may reuse the task-specific parameters of the model for a previous task or should introduce new task-specific parameters.

As described herein, the disclosure is directed to a novel CL framework which retains the advantages of CL task processing through decreasing parameter (memory) expansion and saving computation cost, by considering longer sequences of tasks and identifying similar tasks. For example, when a task is previously learned by the model, a new task introduced to a model may be a similar task. Thus, the knowledge gained from the task previously learned can be reused when the similar task is re-learned in the future. In this case, therefore, it is assumed that no task identifier is given, meaning that the task that now being learned is unknown. To leverage the previous knowledge, it is identified whether a similar task is already learned by the model. The disclosure thus teaches a novel configuration for leveraging previously learned similar tasks and reusing the previously used parameters when the new similar task is learned.

The disclosure further describes a novel similar task detection engine to recognize and detect previously learned similar task(s). In various embodiments, the engine includes a task-specific variational auto encoder (VAE), though many networks may be used such as, without limitation, a generative adversarial networks (GAN) autoencoder and a separately trained encoder. The VAE performs a distribution consistency estimation as well as a predictor-label association analysis in order to detect the previously learned similar task(s).

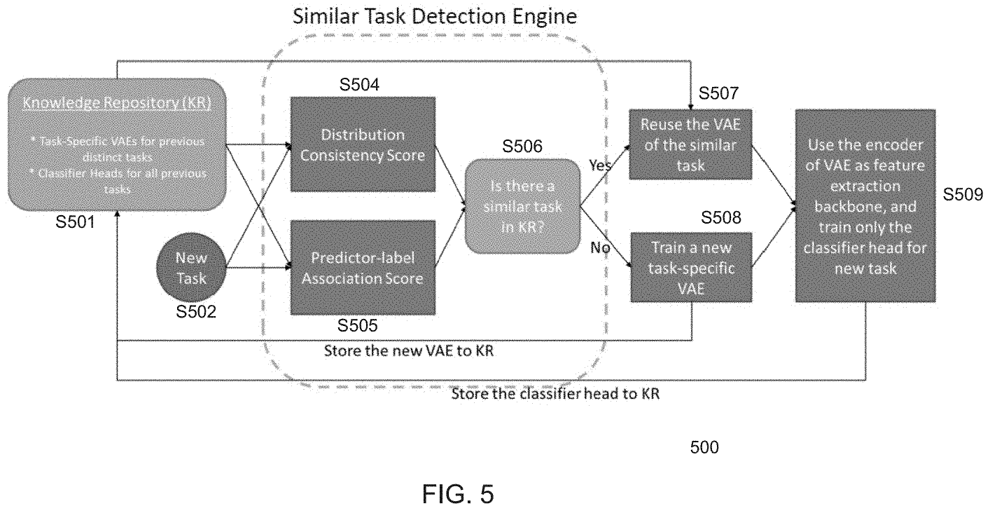

FIG. 5 illustrates a block diagram of a CL method 500, according to an embodiment. In FIG. 5, past knowledge is stored in a knowledge repository (KR) in step S501. Here, task specific VAEs for previous distinct tasks and classifier heads for all previous tasks are stored in the KR in a knowledge-based function of the method. When a new task is introduced to the model in step S502 (i.e., new data is collected), the new task is input into a similar task detection engine in step S503, which determines a distribution consistency score in step S504 and a predictor-label association score in step S505. The distribution consistency score is used to estimate a training dataset similarity between the new task and a previous task and the predictor-label association score is used to estimate the test error when using a previous task-specific encoder for classification of a new task. Both of these scores are used in step S506 to determine whether a similar task to the new task is stored in the KR. If so (“Yes” in step S506), the VAE of the similar task is reused in step S507. If not (“No” in step S506), a new task-specific VAE is trained for the new task in step S508 and the new VAE is stored in the KR. In step S509, and pursuant to either step S507 or step S508, the encoder portion of the VAE is used as a feature extraction backbone and only trains the classifier head for the new task. The trained classifier head is also stored in the KR.

It is noted that the CL method S500 may be learned by a mobile device and a server, from a practical standpoint. For example, the KR in step S501 may be stored in a server. When the new data is collected from a mobile device in step S502, the scores in steps S504 and S505 are queried in the server which determines whether the data or task is new in step S506. Based on that determination, the server may send the VAE to be reused in step S507 or the server or mobile device trains the new task-specific VAE in step S508. Alternatively, the components in this method of the mobile device and server may vary, or a mobile platform or a server platform may solely perform the method.

As a result of the novel task processing method depicted in FIG. 5, low computation cost is incurred for identifying whether a similar task-trained model is available for reuse. Moreover, there is no requirement for a large dataset for the similar task identification module. This ensures faster output during the identification process and is beneficial when the user may have insufficient data to train a good model while the model for the similar task in the KR is well-trained. That is, the disclosed similar task detection methods, i.e., the distribution consistency estimator and predictor-label association analysis herein, do not require many data samples as revealed below in Equations (6), (7) and (8), since pre-trained task-specific encoders are leveraged herein.

In various embodiments, the VAE used herein may be a task specific VAE with a style-modulation technique to reduce the size of the task specific VAE and memory consumption or any other known VAE to achieve such goals. By using style modulation, it is unnecessary to store full weights (convolution kernels) of the VAEs. Instead, it is only necessary to store the modulation parameters, which are much smaller than weights as revealed below in Equations (1) and (2).

Further details on how the above-mentioned steps in a method of the disclosure may be performed is described below.

1.1 Problem Setting

The TCL scenario for image classification tasks is now considered, where a sequence of tasks {T₁, T₂, . . . , Tₜ₋₁} is incrementally learned and the collection of tasks currently learned is denoted as T={T₁, T₂, . . . , Tₜ₋₁}. The underlying assumption is that, as the number of tasks in T increases, the current task Tₜ will eventually have a corresponding similar task Tₜ^{sim}∈T. Let the set of all dissimilar tasks be Tₜ^{dis}=T\Tₜ^{sim}. Similar and dissimilar tasks are defined as follows.

Similar and dissimilar tasks: Consider two tasks A and B, which are represented by datasets D_{A}{xᵢ^{A}, yᵢ^{A}}ᵢ₌₁ⁿ^{_{A}} and D_{B}{xᵢ^{B}, yᵢ^{B}}ᵢ₌₁ⁿ^{_{B}}, where yᵢ^{A}∈{Y^{A}} and yᵢ^{B}∈{Y^{B}}. If predictors (e.g., images) in {xᵢ^{A}}ᵢ₌₁ⁿ^{_{A}}˜P and {xᵢ^{B}}ᵢ₌₁ⁿ^{_{B}}˜P, and labels {Y^{A}}={Y^{B}}, indicating that data from A and B belong to the same group of classes, and their predictors are drawn from the same distribution P, then it is said that A and B are similar tasks; otherwise, A and B are deemed dissimilar. Notably, when both tasks share the same distribution P, but have different label spaces, they are considered dissimilar.

As described in this disclosure, techniques are utilized to identify Tₜ^{sim} among T without training a new model (or learning parameters) for Tₜ, by leveraging a task similarity identification function that will enable the system to reuse the parameters of Tₜ^{sim} when identification of a previously seen task is successful. Alternatively, the system may introduce new parameters for the dissimilar task. As a result, the system will attempt to learn parameters for the set of unique tasks, which in a long sequence of tasks (e.g., greater than 20 tasks) is assumed to be smaller than the sequence length. In practice, to handle memory efficiently, completely different sets of parameters for every unique task do not have to be introduced, but rather, global and task-specific parameters are defined to further control model growth. For this purpose, the efficient feature transformations for convolutional models described below are leveraged.

1.2 Task-Specific Adaptation Via Feature Transformation Techniques

The efficient feature transformation (EFT) framework has been described above with reference to previous CL models upon which this disclosure improves, such that instead of fine-tuning all the parameters in a well-trained (pretrained) model, one can instead partition the network into a (global) backbone model and task-specific feature transformations. Given a trained backbone convolutional neural network, the convolutional feature maps F for each layer can be transformed into task-specific feature maps W by implementing small convolutional transformations.

In the disclosed setting, only W is learned for task Tₜ to reduce the parameter count as well as the memory footprint required for new tasks. Specifically, the feature transformation involves two types of convolutional kernels, namely, ω^{s}∈R^{3×3×a} for capturing spatial features within groups of channels and ω^{d}∈R^{3×3×b} for capturing features across channels at every location in F, where a and b are hyperparameters controlling the size of each feature map group.

The transformed feature maps W=W^{s}+γW^{d} are obtained from W^{s}=[W_{0:a-1}^{s}| . . . |W_{(K-a):K}^{s}] in Equation (1) and W^{d}=[W_{0:b-1}^{s}| . . . |W_{(K-b):K}^{d}] in Equation (2) as follows:

$${W}_{a i : ( a i + a - 1 )}^{s} = [ {ω}_{i , 1}^{s} * {F}_{a i : ( a i + a - 1 )} \vert … \vert {w}_{i , a}^{s} * {F}_{a i : ( a i + a - 1 )} ] , i ∈ \{ 0 , … , \frac{K}{a} - 1 \} , \qquad ( 1 )$$

$${W}_{b i : ( b i + b - 1 )}^{d} = [ {ω}_{i , 1}^{d} * {F}_{b i : ( b i + b - 1 )} \vert … \vert {w}_{i , b}^{d} * {F}_{b i : ( b i + b - 1 )} ] , i ∈ \{ 0 , … , \frac{K}{b} - 1 \} , \qquad ( 2 )$$

where the feature maps F∈R^{M×N×K} and W∈R^{M×N×K} have spatial dimensions M and N, K is the number of feature maps, | is the concatenation operation, K/a and K/b are the number of groups into which F is split for each feature map, γ∈{0,1} indicates whether the point-wise convolutions ω^{d} are employed, and W_{ai:(ai+a-1)}^{s}∈R^{M×N×a} and W_{bi:(bi+b-1)}^{d}∈R^{M×N×b} are slices of the transformed feature map. In practice, a<<K and b<<K are set so that the number of trainable parameters per task is substantially reduced. For instance, using a ResNet18 backbone, a=8, and b=16 results in 449 k parameters per new tasks, which is 3.9% the size of the backbone. As previously empirically demonstrated, EFT preserves the substantial representation learning power of ResNet models while significantly reducing the number of trainable parameters per task.

1.3 Task Continual Learning: Mixture Model Perspective

One of the key components when trying to identify similar tasks is to determine whether {xᵢ^{A}}ᵢ₌₁ⁿ^{_{A}} and {xᵢ^{B}}ᵢ₌₁ⁿ^{_{B}} originate from the same distribution P. However, though conceptually simple, this may be challenging when predictors are complex instances such as images. Intuitively, for a sequence of tasks T={T₁, T₂, . . . , Tₜ₋₁}, with corresponding data D₁, . . . , Dₜ₋₁, Dₜ={xᵢ, yᵢ}ᵢ₌₁ⁿ^{ₜ} consisting of nₜ instances, where xᵢ is an image and yᵢ is its corresponding label, data instances x from the collection of all unique tasks are considered as a mixture model defined below in Equation (3) as follows:

$$p ( x ) = {π}_{*} p ( x \vert {ϕ}_{*} ) + {\sum }_{j = 1}^{t - 1} {π}_{j} p ( x \vert {ϕ}_{j} ) , \qquad ( 3 )$$

In Equation (3), it can be seen that πⱼ is the probability that x belongs to task Tⱼ and p(x|ϕⱼ) is the likelihood of x under the distribution for task Tⱼ parameterized by ϕⱼ. Further, π_{*} and ϕ_{*} denote the hypothetical probability and parameters for a new unseen task *, i.e., distinct from {p(x|ϕⱼ)}ⱼ₌₁^{t-1}. Equation (3) which is reminiscent of a Dirichlet Process Mixture Model (DPMM), can in principle be used to estimate a posteriori that p(Dₜ∈T_{*}) by evaluating Equation (3), which assumes that parameters {π_{*}, π₁, . . . , πₜ₋₁} and {ϕ_{*}, ϕ₁, . . . , ϕₜ₋₁} are readily available. Although the collection of existing tasks T πⱼ and p(x|ϕⱼ) can be effectively estimated using generative models (e.g., the VAE), the parameters for a new task ϕ_{*} and p(x|ϕ_{*}), are much more difficult to estimate because i) if a generative model is built for the new dataset Dₜ to obtain ϕₜ and then Equation (3) is calculated, it is almost guaranteed that Dₜ corresponding to Tₜ will be more likely under p(×|ϕ_{*}=ϕⱼ) than any other existing task distribution {p(x|ϕⱼ)}ⱼ₌₁^{t-_1}, and alternatively, ii) if p(x|ϕ_{*)} is set to some prior distribution, e.g., a pretrained generative model, it will not be selected, particularly in scenarios with complex predictors such as images. This has been empirically verified in early stages of development using both pretrained generative models admitting (marginal) likelihood estimation and anomaly detection models based on density estimators.

Section 2 describes how to leverage Equation (3) to identify new tasks in the context of TCL without using data from Tₜ for learning or specifying a prior distribution for p(x|ϕ_{*}).

1.4 Estimating the Association Between Predictors and Labels

The mixture model perspective for TCL in Equation (3) reveals how to compare the distribution of predictors for different tasks but does not provide any insight about the strength of the association between predictors and labels for dataset Dₜ corresponding to task Tₜ. It has been shown that overparameterized neural network classifiers can attain zero training error, regardless of the strength of association between predictors and labels, and in an extreme case, even for randomly labeled data. However, a model trained with random labels will not generalize.

The properties of suitably labeled data that control generalization ability have been studied, and a generalization bound on the test error (empirical risk) for arbitrary overparameterized two-layer neural network classifiers with rectified linear units (ReLU) is disclosed. Unlike previous works on generalization bounds for neural networks, the bounds in the disclosure can be effectively calculated without training the network or making assumptions about its size (e.g., number of hidden units). The complexity measure, which is shown below in Equation (4), is set to directly quantify the strength of the association between data and labels without learning. More precisely, for dataset D={xᵢ, yᵢ}ᵢ₌₁ⁿ of size n, the generalization bound in Equation (4) below is an upper bound on the (test) error conditioned on D,

$$S ( D ) = \sqrt{\frac{2 {y}^{T} {H}^{- 1} y}{n}} , \qquad ( 4 )$$

where y=(y₁, . . . yₙ)^{T} and matrix H=R^{n×n}, which can be seen as a Gram matrix for a ReLU activation function is defined in Equation (5) as follows.

$${H}_{i k} = {E}_{w \sim N ( 0 , I )} [ {x}_{i}^{T} {x}_{k} {1}_{\{ {w}^{T} {x}_{i} \geq 0 , {w}^{T} {x}_{k} \geq 0 \}} ] = \frac{{x}_{i}^{T} {x}_{k} ( π - arc cos ( {x}_{i}^{T} {x}_{k} ) )}{2 π} , ∀ i , k ∈ \{ 1 , 2 , … , n \} , \qquad ( 5 )$$

where Hᵢₖ is the (i, k)-th entry of H, N(0, l) denotes the standard Gaussian distribution, w is a weight vector in the first layer of the two-layer neural network, and 1_{{•}} is an indicator function. Empirically, it has been shown that the complexity measure in Equation (4) can distinguish between strong and weak associations between predictors and labels. Effectively, weak associations tend to be consistent with randomly labeled data, and thus are unlikely to generalize. Therefore, a high generalization bound is achieved, as revealed above in Equation (4), and is utilized to identify task similarity.

In Section 2, Equation (4) will be leveraged as a metric for similar task detection, which will be recast as a measure to quantify the association between the labels for a given task and the features from encoders learned from previously seen tasks.

2. Detection and Repurposing of Similar Tasks

It will now be described how a similar task detection and repurposing (SRD) framework for task continual learning, which though tailored to image classification tasks, can be in principle reused for other modalities such as text and structured data. Specifically, the framework consists of the following two components: (i) task-specific encoders {Eⱼ(•)}ⱼ₌₁^{t-1} for T={Tⱼ}ⱼ₌₁^{t-1}; and (ii) a mechanism for similar task identification structured as two separate but complementary components, namely, a measure of distributional similarity between the current task Tₜ and each of all previous tasks T, and a predictor-to-label association similarity, each of which leverages the mixture model perspective and the complexity measure introduced in Sections 1.3 and 1.4, respectively. For the task-specific encoders, task-specific generative models {Gⱼ(•)}ⱼ₌₁^{t-1} specified as VAEs that admit (marginal) likelihood estimation via the evidence lower bound (ELBO) are used, and for the for similar task identification. the measure S(•) in Equation (4) is used. The complete framework is presented below in the SDR Framework process. In a nutshell, similar task identification results in one of two outcomes, namely, a previously seen task is identified as being similar to Tₜ, in which case the corresponding encoder will be used, but a task-specific classification head will be learned. Alternatively, if Tₜ is deemed as a new unseen task, a new task-specific VAE, decoder (generator), and classification head will be learned. The classification head for Tₜ is defined as p(y|x)=fₜ(Eₜ(x)) and specified as a fully connected network.

SDR Framework

| Data: Dₜ = {xᵢ^{t}, yᵢ^{t}}ᵢ₌₁ⁿ^{ₜ}, t ∈ [1, N]; (Only Dₜ available | |
|---|---|
| at time t) | |
| Result: {Eₘ}_{m=1'}^{C}, {Gₘ}_{m=1'}^{C}, with C being the | |
| number of unique tasks recognized by the system | |
| Starting with: E₀, {Eₘ} ← {Eₘ}ₘ₌₁³; G₀ (might or | |
| might not be available), {Gₘ} ← {Gₘ}ₘ₌₁³ | |
| for t ← 1 to N do | |
| \| for j ≤ t - 1 do | |
| \| \| for i ← 1 to n^{t} do | |
| \| \| \| p(uᵢ = j\|xᵢ); /* Distributional | |
| \| \| \| Consistency Estimator */ | |
| \| \| end | |
| \| \| p( [symbol] ₜ = [symbol] ⱼ = [symbol] [p(uᵢ = j\|xᵢ)] | |
| \| end | |
| \| [symbol] = arg maxⱼ {p( [symbol] ₜ = [symbol] ⱼ)}₌₁^{t-1} | |
| \| for j ≤ t - 1 do | |
| \| \| ${H}_{i k}^{j , t} = \frac{{e}_{i}^{j , {t}^{T}} {e}_{k}^{k , t} ( π - arccos ( {e}_{i}^{j , {t}^{T}} {e}_{k}^{j , t} ) )}{2 π} ,$ | |
| \| \| A^{j,t} = y^{T}(H^{j,t})⁻¹y | |
| \| \| $S ( j , t ) ← \sqrt{\frac{2 \vert \vert {A}^{j , {t}^{T}} {A}^{j , t} {\vert \vert}_{2}^{2}}{{n}_{t}}} ;$ | /* Predictor-label |

| | Association Analysis */
| end
| [symbol] = arg minⱼ {S(j,t)}ⱼ₌₁^{t-1}
| if Tₐ = = [symbol] then
| reuse feature encoder and VAE model from task
| [symbol] or task [symbol] , only train a new classification head
fₜ for [symbol]
| | Eₜ ← Eₐ
| | Gₜ ← Gₐ
| else train new models for task [symbol]
| | repeat
| | | B ← random sampled mini-batch from Dₜ
| | | $g = {∇}_{{θ}_{{E}_{t}}} ℒ ( {ϕ}_{{E}_{t}} , B )$
| | | θ_{E}_{ₜ} ← AdamOptimizer(θ_{E}_{ₜ}, g)
| | until θ_{E}_{ₜ} converges;
| | repeat
| | | B ← random sampled mini-batch from Dₜ
| | | $g = {∇}_{{ψ}_{{G}_{t} , {ϕ}_{{G}_{t}}}} ℒ ( {ψ}_{{G}_{t}} , {ϕ}_{{G}_{t}} , B )$
| | | ψ_{G}_{ₜ}_{,}, ϕ_{G}_{ₜ} ← AdamOptimizer(ψ_{G}_{ₜ}_{,}, ϕ_{G}_{ₜ}, g)
| | until ψ_{G}_{^{t}}_{,}, ϕ_{G}_{^{t}} converges;
| end
end

2.1 Task-Specific Encoder

To ensure efficient feature transformations, a pretrained backbone encoder E₀(•) is specified, and for each new unseen task, E₀(•) is adapted into Eₜ(•) using an EFT module that is learned together (end-to-end) with the task-specific classification head p(y|x)=fₜ(Eₜ(x)) in a supervised fashion using Dₜ, while maintaining E₀(•) as fixed.

2.2 Similar Task Identification

As previously described, the procedure to identify similar tasks for a new task Tₜ among existing T={Tⱼ}ⱼ₌₁^{t-1}, amounts to estimating the distributional similarity of the predictors and the strength of the association between labels and predictors.

When given a sequence of tasks T with corresponding encoders and generators {Eⱼ(•)}ⱼ₌₁^{t-1} and {Gⱼ(•)}ⱼ₌₁^{t-1}, respectively, Equation (3) is used to estimate the likelihood that predictors in Dᵣ are consistent with the generator for a previously seen task. In Equation (6), that is,

$$p ( {P}_{t} = {P}_{j} ) = {E}_{{x}_{i} ∈ {D}_{t}} [ p ( {u}_{i} = j \vert {x}_{i} ) ] = \frac{1}{n} {\sum }_{i = 1}^{n} \frac{{π}_{j} p ( {x}_{i} \vert {ϕ}_{j} )}{{\sum }_{{j}^{′}} {π}_{{j}^{′}} p ( {x}_{i} \vert {ϕ}_{{j}^{′}} )} , \qquad ( 6 )$$

where p (Pₜ=Pⱼ) indicates the probability that Pₜ and Pⱼ have the same predictor distributions. In practice, the ELBO of a VAE pair Eₘ(•) and Gₘ(•) is used to approximate the (marginal) likelihood p(xᵢ|ϕⱼ) parameterized by ϕⱼ, which encapsulates the parameters of both Eⱼ(•) and Gⱼ(•), i.e., encoder and generator, respectively. However, Pₜ=Pⱼ, though useful for previously seen tasks T, does not help to identify new unseen tasks that will be consistent with a hypothetical distribution P_{*} specified as p (xᵢ|ϕ_{*)} and parameterized by ϕ_{*}. Intuitively, given a new unseen task Tₜ, p(Pₜ=Pⱼ) is likely to be a drawn from a uniform distribution in t−1 dimensions, so when p (Pₜ=Pⱼ)≈1/(t−1), for j=1, . . . , t−1, the predictors for the new task are likely from a new unseen task. Alternatively, when p(Pₜ=Pⱼ)→1, for some task Tⱼ, the predictors in Dᵣ are likely to be consistent in distribution to Pⱼ, i.e., to predictors from dataset Dⱼ.

The distributional consistency estimator in Equation (6) only estimates the probability that predictors in Dₜ are consistent in distribution to that of Dⱼ. However, there remains the need to estimate the likelihood that encoder Eⱼ(•) built from D_{g} is strongly associated with the labels of interest in Dₜ without building a classification model for Dₜ using Eⱼ(•). For this purpose, the complexity measure in Equation (4) is leveraged and is written below in terms of the task-specific encoders.

Following the construction of H as defined in Equation (5), this Equation is redefined in terms of the task-specific encoders. Specifically, given encoders {Eⱼ(•)}ⱼ₌₁^{t-1} and dataset Dᵣ={xᵢ^{t}, yᵢ^{t}}ᵢ₌₁ⁿ^{ₜ} for task Tₜ, features are extracted for the predictors in Dₜ using all available encoders, i.e., {{Eⱼ(xᵢ^{t})}ᵢ₌₁ⁿ^{ₜ}}ⱼ₌₁^{t-1}. For convenience, let eᵢ^{j,t}=Eⱼ(xᵢ^{t}). The Gram matrix H^{j,t} corresponding to encoder j and dataset Dₜ in Equation (5) is re-written as the following in Equation (7):

$${H}_{i k}^{j , t} = \frac{{( {e}_{i}^{j , t} )}_{i}^{T} {e}_{k}^{j , t} ( π - arc cos ( {( {e}_{i}^{j , t} )}_{i}^{T} {e}_{k}^{j , t} ) )}{2 π} , ∀ i , k ∈ \{ 1 , 2 , … , n \} , \qquad ( 7 )$$

which is a multi-class extension of the complexity measure for binary classification tasks. Note that the Gram matrix Hᵢₖ^{j,t}∈Rⁿ^{ₜ}^{×n}^{ₜ} has the same formulation as for when y^{t}=(y₁^{t}, . . . yₙ^{t})∈{0,1}^{c×n} where c is the number of classes. Let A^{j,t}=y^{T}(H^{j,t})⁻¹y∈R^{c×c} the similarity metric S between tasks Tₜ and Tⱼ via encoder Eⱼ(•) is defined in Equation (8) as follows:

$$S ( j , t ) = \sqrt{\frac{2 {‖ {( {A}^{j , t} )}^{T} {A}^{j , t} ‖}_{2}^{2}}{{n}_{t}}} , \qquad ( 8 )$$

where ∥•∥₂² is the Frobenius Norm, nₜ is the size of Dₜ.

In practice, feature sets {eᵢ^{j,t}}ᵢ₌₁ⁿ^{ₜ} are obtained with all available encoders {Eⱼ(•)}ᵢ₌₁^{t-1} for task collection T, and S(j, t) is calculated for a new task Dₜ. Then, Tₐ is selected with

$$a = arg {min}_{j} {\{ S ( j , t ) \}}_{j = 1}^{t - 1} .$$

For each data point i in Dₜ, p(uᵢ=j|xᵢ), for j=1, . . . , t−1 is obtained using the ELBO to evaluate p(xᵢ|ϕⱼ). Then, the probability of consistency between Tₜ and Tⱼ via (4) is estimated and T_{b} is selected with

$$b = arg {min}_{j} {\{ p ( {P}_{t} = {P}_{j} ) \}}_{j = 1}^{t - 1} .$$

If Tₐ=T_{b}, it is determined that Tₐ is a similar task; otherwise, it is determined that Tₜ is a dissimilar task. As described above in FIG. 5, for the collection of currently learned tasks, a KR is maintained containing (for the previously seen tasks T) E₀(•),{Eⱼ(•)}ⱼ₌₁^{t-1},{Gⱼ(•)}ⱼ₌₁^{t-a},{fⱼ(•)}ⱼ₌₁^{t-1}, i.e., the backbone encoder, task-specific encoder-decoder pairs, and the classification heads, respectively. The SDR framework is further illustrated above in the above SDR framework process.

Thus, the predictor-label association analysis herein sets for that for property of S, a true label indicates a good generalization (i.e., when the train data and the test data are similar), such that S is tightly bound on the test error, and a noisy label indicates a poor generalization (i.e., large bound), such that S is loosely bound on the test error. If different feature extractors are used to encode a dataset D^{t}, a good encoder indicates good generalization, such that S has a lowest value, and a random encoder indicates a poor generalization, such that S has a higher value than that of the good encoder. This is used to determine whether similar data is in the previous task stored in the KR. The VAE is trained for previous data. If the similar data exists, low test data results and good generalization for new data is achieved.

As a result, the above-described methods of the disclosure incur low computational cost and require only a minimal amount of data for the new task(s) to be learned. Therefore, the methods may be quickly performed.

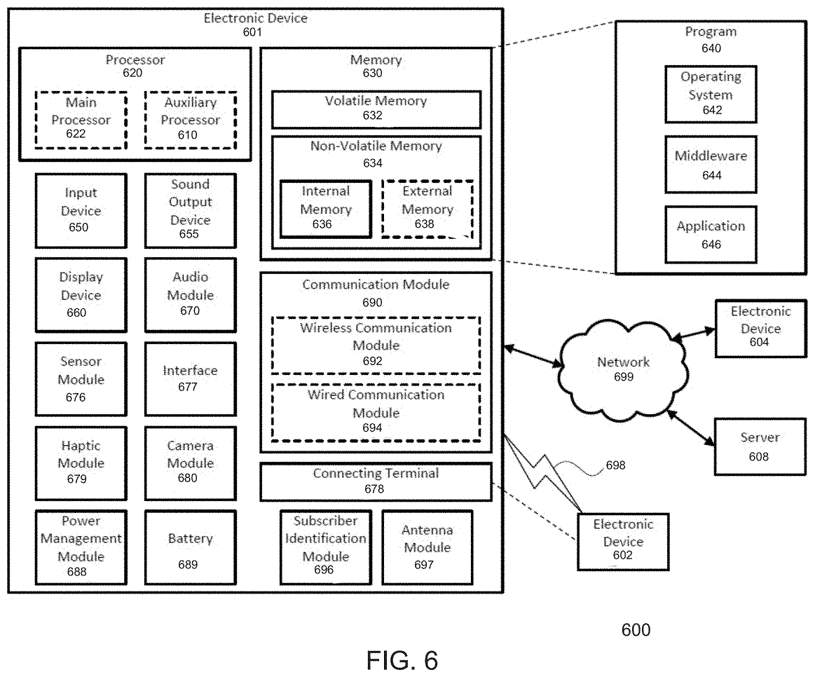

FIG. 6 is a block diagram of an electronic device in a network environment 600, according to an embodiment. Network environment 600 may be a system framework on which a method, such as method 500, may operate according to the embodiments described herein. Referring to FIG. 6, an electronic device 601 in a network environment 600 may communicate with an electronic device 602 via a first network 698 (e.g., a short-range wireless communication network), or an electronic device 604 or a server 608 via a second network 699 (e.g., a long-range wireless communication network). The electronic device 601 may communicate with the electronic device 604 via the server 608. The electronic device 601 may include a processor 620, a memory 630, an input device 640, a sound output device 655, a display device 660, an audio module 670, a sensor module 676, an interface 677, a haptic module 679, a camera module 680, a power management module 688, a battery 689, a communication module 690, a subscriber identification module (SIM) card 696, or an antenna module 694. In one embodiment, at least one (e.g., the display device 660 or the camera module 680) of the components may be omitted from the electronic device 601, or one or more other components may be added to the electronic device 601. Some of the components may be implemented as a single integrated circuit (IC). For example, the sensor module 676 (e.g., a fingerprint sensor, an iris sensor, or an illuminance sensor) may be embedded in the display device 660 (e.g., a display).

The processor 620 may execute, for example, software (e.g., a program 640) to control at least one other component (e.g., a hardware or a software component) of the electronic device 601 coupled with the processor 620 and may perform various data processing or computations, such as for the CL methods as disclosed herein. As at least part of the data processing or computations, the processor 620 may load a command or data received from another component (e.g., the sensor module 646 or the communication module 690) in volatile memory 632, process the command or the data stored in the volatile memory 632, and store resulting data in non-volatile memory 634.

The processor 620 may include a main processor 621 (e.g., a central processing unit (CPU) or an application processor (AP)), and an auxiliary processor 623 (e.g., a graphics processing unit (GPU), an image signal processor (ISP), a sensor hub processor, or a communication processor (CP)) that is operable independently from, or in conjunction with, the main processor 621. Additionally or alternatively, the auxiliary processor 623 may be adapted to consume less power than the main processor 621, or execute a particular function. The auxiliary processor 623 may be implemented as being separate from, or a part of, the main processor 621.

The auxiliary processor 623 may control at least some of the functions or states related to at least one component (e.g., the display device 660, the sensor module 676, or the communication module 690) among the components of the electronic device 601, instead of the main processor 621 while the main processor 621 is in an inactive (e.g., sleep) state, or together with the main processor 621 while the main processor 621 is in an active state (e.g., executing an application).

The auxiliary processor 623 (e.g., an image signal processor or a communication processor) may be implemented as part of another component (e.g., the camera module 680 or the communication module 690) functionally related to the auxiliary processor 623.

The memory 630 may store various data used by at least one component (e.g., the processor 620 or the sensor module 676) of the electronic device 601. The various data may include, for example, software (e.g., the program 640) and input data or output data for a command related thereto. The memory 630 may include the volatile memory 632 or the non-volatile memory 634.

The program 640 may be stored in the memory 630 as software, and may include, for example, an operating system (OS) 642, middleware 644, or an application 646.

The input device 650 may receive a command or data to be used by another component (e.g., the processor 620) of the electronic device 601, from the outside (e.g., a user) of the electronic device 601. The input device 650 may include, for example, a microphone, a mouse, or a keyboard.

The sound output device 655 may output sound signals to the outside of the electronic device 601. The sound output device 655 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 660 may visually provide information to the outside (e.g., a user) of the electronic device 601. The display device 660 may include, for example, a display, a hologram device, or a projector and control circuitry to control a corresponding one of the display, hologram device, and projector. The display device 660 may include touch circuitry adapted to detect a touch, or sensor circuitry (e.g., a pressure sensor) adapted to measure the intensity of force incurred by the touch.

The audio module 670 may convert a sound into an electrical signal and vice versa. The audio module 670 may obtain the sound via the input device 650 or output the sound via the sound output device 655 or a headphone of an external electronic device 602 directly (e.g., wired) or wirelessly coupled with the electronic device 601.

The sensor module 676 may detect an operational state (e.g., power or temperature) of the electronic device 601 or an environmental state (e.g., a state of a user) external to the electronic device 601, and then generate an electrical signal or data value corresponding to the detected state. The sensor module 676 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 677 may support one or more specified protocols to be used for the electronic device 601 to be coupled with the external electronic device 602 directly (e.g., wired) or wirelessly. The interface 677 may include, for example, a high-definition multimedia interface (HDMI), a universal serial bus (USB) interface, a secure digital (SD) card interface, or an audio interface.

A connecting terminal 678 may include a connector via which the electronic device 601 may be physically connected with the external electronic device 602. The connecting terminal 678 may include, for example, an HDMI connector, a USB connector, an SD card connector, or an audio connector (e.g., a headphone connector).

The haptic module 679 may convert an electrical signal into a mechanical stimulus (e.g., a vibration or a movement) or an electrical stimulus which may be recognized by a user via tactile sensation or kinesthetic sensation. The haptic module 679 may include, for example, a motor, a piezoelectric element, or an electrical stimulator.

The camera module 680 may capture a still image or moving images. The camera module 680 may include one or more lenses, image sensors, image signal processors, or flashes.

The power management module 688 may manage power supplied to the electronic device 601. The power management module 688 may be implemented as at least part of, for example, a power management integrated circuit (PMIC).

The battery 689 may supply power to at least one component of the electronic device 601. The battery 689 may include, for example, a primary cell which is not rechargeable, a secondary cell which is rechargeable, or a fuel cell.

The communication module 690 may support establishing a direct (e.g., wired) communication channel or a wireless communication channel between the electronic device 601 and the external electronic device (e.g., the electronic device 602, the electronic device 604, or the server 608) and performing communication via the established communication channel. The communication module 690 may include one or more communication processors that are operable independently from the processor 620 (e.g., the AP) and supports a direct (e.g., wired) communication or a wireless communication. The communication module 690 may include a wireless communication module 692 (e.g., a cellular communication module, a short-range wireless communication module, or a global navigation satellite system (GNSS) communication module) or a wired communication module 694 (e.g., a local area network (LAN) communication module or a power line communication (PLC) module). A corresponding one of these communication modules may communicate with the external electronic device via the first network 698 (e.g., a short-range communication network, such as Bluetooth™, wireless-fidelity (Wi-Fi) direct, or a standard of the Infrared Data Association (IrDA)) or the second network 699 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 692 may identify and authenticate the electronic device 601 in a communication network, such as the first network 698 or the second network 699, using subscriber information (e.g., international mobile subscriber identity (IMSI)) stored in the subscriber identification module 696.

The antenna module 697 may transmit or receive a signal or power to or from the outside (e.g., the external electronic device) of the electronic device 601. The antenna module 697 may include one or more antennas, and, therefrom, at least one antenna appropriate for a communication scheme used in the communication network, such as the first network 698 or the second network 699, may be selected, for example, by the communication module 690 (e.g., the wireless communication module 692). The signal or the power may then be transmitted or received between the communication module 690 and the external electronic device via the selected at least one antenna.

Commands or data may be transmitted or received between the electronic device 601 and the external electronic device 604 via the server 608 coupled with the second network 699. Each of the electronic devices 602 and 604 may be a device of a same type as, or a different type, from the electronic device 601. All or some of operations to be executed at the electronic device 601 may be executed at one or more of the external electronic devices 602, 604, or 608. For example, if the electronic device 601 should perform a function or a service automatically, or in response to a request from a user or another device, the electronic device 601, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 601. The electronic device 601 may provide the outcome, with or without further processing of the outcome, as at least part of a reply to the request. To that end, a cloud computing, distributed computing, or client-server computing technology may be used, for example.

While the present disclosure has been described with reference to certain embodiments, various changes may be made without departing from the spirit and the scope of the disclosure, which is defined, not by the detailed description and embodiments, but by the appended claims and their equivalents.

What is claimed is:

1. A method of continual learning, comprising:
maintaining a memory comprising one or more previously learned tasks;
determining, in response to receiving a new task, one of more similarities between at least one previously learned task and the new task;
generating, based on the one or more similarities determined and a previously used task-specific encoder corresponding to the at least one previously learned task, a test error value for classifying the new task; and
applying the previously used task-specific encoder to the new task based on the generated test error value.

2. The method of claim 1, further comprising:
determining whether a similar task to the new task is stored in the memory,
wherein the previously used task specific encoder is applied to the new task in response to determining that the similar task is stored in the memory.

3. The method of claim 2, further comprising:
training a new task specific encoder when determining that no similar task to the new task is stored in the memory, and
storing the new task specific encoder in the memory.

4. The method of claim 3, further comprising:
using an encoder portion of the task specific encoder as a feature extraction backbone to train only a classifier head for the new task.

5. The method of claim 4, further comprising:
storing the classification head for the new task in the memory.

6. The method of claim 4,
wherein the encoder portion of the task specific encoder is used to train only the classifier head for the new task based on the re-used task specific encoder or the trained new task specific encoder.

7. The method of claim 3,
wherein a style modulation technique is used to train the new task specific encoder when determining that no similar task to the new task is stored in the memory.

8. The method of claim 3,
wherein the similarity is determined based on a score of a training memory for a task, the score being calculated by a distribution consistency estimator.

9. The method of claim 8,
wherein the similarity is determined based on a score calculated in a predictor-label association analysis.

10. A user equipment (LIE), comprising:
at least one processor; and
at least one memory operatively connected with the at least one processor, the at least one memory storing instructions, which when executed, instruct the at least one processor to perform a method of continual learning by:
maintaining the memory comprising one or more previously learned tasks;
determining, in response to receiving a new task, one of more similarities between at least one previously learned task and the new task;
generating, based on the one or more similarities determined and a previously used task-specific encoder corresponding to the at least one previously learned task, a test error value for classifying the new task; and
applying the previously used task-specific encoder to the new task based on the generated test error value.

11. The UE of claim 10,
wherein the processor further performs the method by determining whether a similar task to the new task is stored in the memory, and
wherein the previously used task specific encoder is applied to the new task in response to determining that the similar task is stored in the memory.

12. The UE of claim 11, wherein the processor further performs the method by:
re-using the previously used task specific encoder of the similar task when determining that the similar task is stored in the memory.

13. The UE of claim 12, wherein the processor further performs the method by:
training a new task specific encoder when determining that no similar task to the new task is stored in the memory, and
storing the new task specific encoder in the memory.

14. The UE of claim 13, wherein the processor further performs the method by:
using an encoder portion of the task specific encoder as a feature extraction backbone to train only a classifier head for the new task.

15. The UE of claim 14, wherein the processor further performs the method by:
transmitting the classification head for the new task to the server to be stored in the memory.

16. The LE of claim 14,
wherein the encoder portion of the task specific encoder is used to train only the classifier head for the new task based on the re-used task specific encoder or the trained new task specific encoder.

17. The UE of claim 13,
wherein a style modulation technique is used to train the new task specific encoder when determining that no similar task to the new task is stored in the memory.

18. The UE of claim 13,
wherein the similarity is determined based on a score of a training memory for a task, the score being calculated by a distribution consistency estimator.

19. The UE of claim 18,
wherein the test error is determined based on a score calculated in a predictor-label association analysis.
